(19) United States
(12) Patent Application Publication
(10) Pub. No.: US 2009/0266746 A1
(43) Pub. Date: Oct. 29, 2009

(54) MINERAL ORE FLOTATION AID

(76) Inventors: David Henry Behr, Ancaster (CA); Philip Croucamp, Midrand (ZA); Caroline Chihyu Sui, Newtown, PA (US)

Correspondence Address: General Electric Company;GE Global Patent Operation, PO Box 861, 2 Corporate Drive, Suite 648, Shelton, CT, 06484, US

(21) Appl. No.: 12/111,614

(22) Filed: Apr. 29, 2008

(51) Int. Cl. B03D 1/06

(52) U.S. Cl. 209/167

(57) ABSTRACT

A method is provided for enhancing selective separation of ore values by addition of an effective amount of a treatment reagent to the separation process, such as froth flotation. The treatment reagent can be added at different stages, such as to a grinding mill, conditioning tank before flotation, or in the flotation cells before, after or simultaneous to the addition of other conventional flotation reagents. By adding the treatment agent, the recovery of valuable minerals from a froth flotation process is increased. In an embodiment of the present invention, the treatment reagent is a water-soluble ethylene oxide/propylene oxide copolymer.

### FIELD OF THE INVENTION

The present invention is related to mineral ore processing, particularly low-grade ore processing. The present process comprises froth flotation to recover valuable minerals and the reagents used during said process.

### BACKGROUND OF THE INVENTION

Mineral ores such as metallic ore are obtained from deposits referred to as either high or low-grade deposits. One process that is used to recover and concentrate minerals obtained from ores is froth flotation. With the steady depletion of high grade, easy to process ores, the exploitation of low grade, more complex and disseminated ore reserves has become necessary. Because of this, more sophisticated and innovative separation technologies for concentrating valuable minerals are required. In terms of flotation, the development of more selective collectors and reagents is critical to its success in treating these low grade, difficult to process ores.

In a froth flotation process, the ore is subject to comminution, such as by crushing and wet grinding, to reduce particle size of the mineral ore. Additives, such as collectors, frothers, and activators, are added to the ground ore, or pulp, to assist in separating valuable minerals from undesirable gangue portions of the ore in subsequent flotation steps. The pulp is then aerated to produce froth at the surface. The materials that adhere to the bubbles or froth are collected as concentrates. Selective suppressants or depressants inhibit the adhesion of the certain minerals to the bubbles or froth, thus assisting in the separation of the froth products from the minerals in the pulp.

Selectivity in froth flotation is controlled by the selective adsorption of reagents on minerals at the mineral/water interface. Reagents that impart sufficient hydrophobic character to minerals on adsorption, such that they are rendered floatable, are referred to as collectors. In general, the commercial collectors currently used include sulfydryl collector agents such as xanthate, and fatty acid based collector agents such as sodium oleate.

U.S. Pat. No. 4,699,711 discloses a process for the flotation of sulfide minerals using preferably short-chain alkyl-substituted thionocarbamates, while U.S. Pat. No. 5,307,938 teaches the use of polyacrylate polymers, homopolymers and copolymers as a dispersant for iron ore pulps to significantly increase the recovery of iron oxide in deslime, flotation or other separation processes requiring a highly dispersed pulp. A selective separation of ore values is taught in U.S. Pat. No. 6,536,595, which comprises the use of a water-soluble, organophosphonate treatment reagent, preferably combined with a polymeric dispersant.

Accordingly, a need remains for more effective and efficient means for the selective separation of ore values from ground mineral ore containing gangue material. Particularly in view of the increasing requirements of the use of low-grade ores.

### SUMMARY OF THE INVENTION

A method is provided for enhancing selective separation of ore values by addition of an effective amount of a treatment reagent to the separation process, such as froth flotation. The treatment reagent can be added at different stages, such as to a grinding mill, conditioning tank before flotation, or in the flotation cells before, after or simultaneous to the addition of other conventional flotation reagents. By adding the treatment agent, the recovery of valuable minerals from a froth flotation process is increased. In an embodiment of the present invention, the treatment reagent is a water-soluble ethylene oxide/propylene oxide copolymer.

The various features of novelty that characterize the invention are pointed out with particularity in the claims annexed to and forming a part of this disclosure. For a better understanding of the invention, its operating advantages and benefits obtained by its uses, reference is made to the accompanying drawings and descriptive matter. The drawings are not intended as showing the limits of all of the ways the invention can be made and used. Changes to and substitutions of the various components of the invention can of course be made.

The invention resides as well in sub-combinations and sub-systems of the elements described, and in methods of using them.

### BRIEF DESCRIPTION OF THE DRAWINGS

FIG. 1 is a graph depicting the effect of the varying doses of the reagent on metal recovery in accordance with one embodiment of the invention.

### DETAILED DESCRIPTION OF THE INVENTION

The singular forms “a,” “an” and “the” include plural referents unless the context clearly dictates otherwise.

The modifier “about” used in connection with a quantity is inclusive of the stated value and has the meaning dictated by the context (e.g., includes the degree of error associated with measurement of the particular quantity).

“Optional” or “optionally” means that the subsequently described event or circumstance may or may not occur, or that the subsequently identified material may or may not be present, and that the description includes instances where the event or circumstance occurs or where the material is present, and instances where the event or circumstance does not occur or the material is not present.

A method is provided for enhancing selective separation of ore values by addition of an effective amount of a treatment reagent to the separation process, such as froth flotation. The treatment reagent can be added at different stages, such as to a grinding mill, conditioning tank before flotation, or in the flotation cells before, after or simultaneous to the addition of other conventional flotation reagents. By adding the treatment agent, the recovery of valuable minerals from a froth flotation process is increased. In an embodiment of the present invention, the treatment reagent is a water-soluble ethylene oxide/propylene oxide copolymer.

The present process provides a means for improving the separation of mineral values from their associated gangue in a polymetallic ore. The present invention will be described with respect to flotation recovery of metal values from polymetallic ores and separation of valuable metals from complex concentrates containing multiple valuable metals. However, this method may also be compatible with other ore processing systems, wherein mineral values are selectively separated from their associated gangue. The method or process comprises the formation of an aqueous mixture of mineral components and gangue, the addition thereto of an effective amount of a treatment reagent to the mineral processing such that it enhances the mineral recovery, and subjecting said aqueous mixture to a separating process that selectively concentrates metal values in a froth or concentrate. The particular amount that is effective will change depending upon variables, such as but not limited to the particular ore or ores processed and the specific composition of the reagent.

In an embodiment of the invention, the treatment reagent comprises a water-soluble ethylene oxide/propylene oxide copolymer. The copolymer can be of varying forms, and this reagent, when added to the process enhances the recovery of valuable minerals and/or metals from a polymetallic ore feed. The polymetallic ore body may be an ore body, such as an sulfide ore, or other ore body containing several different metal values in commercial or recoverable amounts, which metals may include but is not limited to copper, nickel, molybdenum, chromium, tungsten, silver, lead, cobalt, zinc or other associated metals. Other polymetallic ore bodies, such as oxidized ore bodies, may contain different distributions of metal values. The treatment reagent may selectively affect several of the minerals, selectivity being generally controlled by ‘modifiers’ which affect surface or other properties. The treatment reagent can be added at different stages, such as to a grinding mill, conditioning tank before flotation, or in the flotation cells before, after or simultaneous to the addition of other conventional flotation reagents.

As used herein, the term “EO/PO” is synonymous with the oxyalkylene group and serves as a convenient short hand to designate polyoxyalkylene groups, (ethylene oxide/propylene oxide copolymers). The copolymers are comprised of polyoxyethlene polyoxypropylene polymers, with varying percentages by weight of ethylene oxide. In one embodiment, the copolymer is the product of the controlled addition of propylene oxide to two hydroxyl groups of propylene glycol. Ethylene oxide is then added to sandwich the hydrophobe between hydrophilic groups. Suitable polymeric reagents within the scope of the present invention comprise copolymers having the structure
EO—PO-EO

In an alternate embodiment, the hydrophobic and hydrophilic positions are reversed, such that the hydrophilic group is sandwiched between the hydrophobic groups, as for example
PO-EO—PO

In a further alternate embodiment, the copolymer is the product of a sequential addition of propylene oxide and ethylene oxide to ethylene-diamine. An example of the same may have the structure

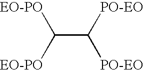

In a further embodiment, the copolymer may also be derived from the sequential addition of propylene oxide and ethylene oxide to ethylene-diamine, but the hydrophobic and hydrophilic blocks are reversed, to create a structure

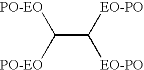

The backbone in either of the above two embodiments can vary. Examples of the same, but not meant to be limiting in any way, include erythritol

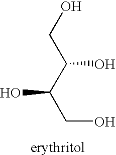

and penta-erythritol

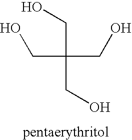

A further example of a backbone for the branched embodiments is N—CH₂—CH₂—N.

The reagent may also be formed from various combinations of the embodiments of the copolymer. In any of the embodiments, the amount of EO present in the copolymer is from about 10 to about 90 percent by weight, with one embodiment being from about 20 to about 80% by weight. Additionally, the amount of PO present in the copolymer is from about 90 to about 10% by weight, with an embodiment of from about 80 to about 20% by weight. Examples of the copolymers include by are not limited to Pluronic® L61, L62, L81, L01, L42, L72, F108, F98 and F88 (BASF Corporation, Mount Olive, N.J., USA), as well as Tergitol® L-61, L-62, L-81, L-101 (The Dow Chemical Company, Midland, Mich., USA).

The number average molecular weight of the water-soluble copolymers of the present invention fall within the range of from about 1,000 to about 50,000, with an embodiment in the range of about 2,000 to about 20,000.

The method or process comprises the addition of an effective amount of the reagent to the froth flotation process which enhances the ore recovery, with the particular amount that is effective changing depending upon variables, such as but not limited to the particular ore processed and the specific composition of the reagent. The reagent may be added during the wet grinding of ore, or may be added later to the ground slurry and is added in an amount of from about 0.01 grams/ton dry solids to about 100.0 grams/ton dry solids, with an embodiment comprising from about 0.1 to about to about 15.0 grams/dry ton.

The method may be carried out at varying pH levels, which may be dictated by the conditions at the time of the froth flotation. However, the pH range for the present process is from about 5 to about 11, with an embodiment of alkaline pH in many instances.

The recovery value is the percentage of valuable metals in concentrates relative to the valuable metals in the ore being processed. With low-grade ore, it is not unusual to have a recovery of 80%, thereby leaving 20% of the valuable metal behind. By using the presently disclosed reagent in the process, such as by froth flotation, the recovery value can be increased, resulting in an increase of revenue from the ore. Generally, a froth flotation process is applied to low grade ore, for example having less than 1% metal, and the selective attachment of air bubbles to lift the hydrophobic particle into a froth results in creation of a froth component that is many times more concentrated than the feed and can be economically processed. Several measures of economic value are the percentage of metal recovered, the level of a metal value in the concentrate and the level of metal remaining in the process tailings after flotation. The present method has proven effective to increase the first two measures and decreases the level of residual metal in process tailings. The level of a metal value in a concentrate can be increased greatly, from about five fold to about ten fold or more. The recovery values with the addition of a treatment reagent may increase from about 3 to about 10% or more, up to total recovery levels, depending upon the process and froth concentration steps. When the EO/PO copolymer described herein comprises the reagent, the increase in the recovery values from the addition of the reagent is from about 2 to about 10% increase, with one embodiment showing an increase in recovery of from about 3 to about 8%.

### EXAMPLE

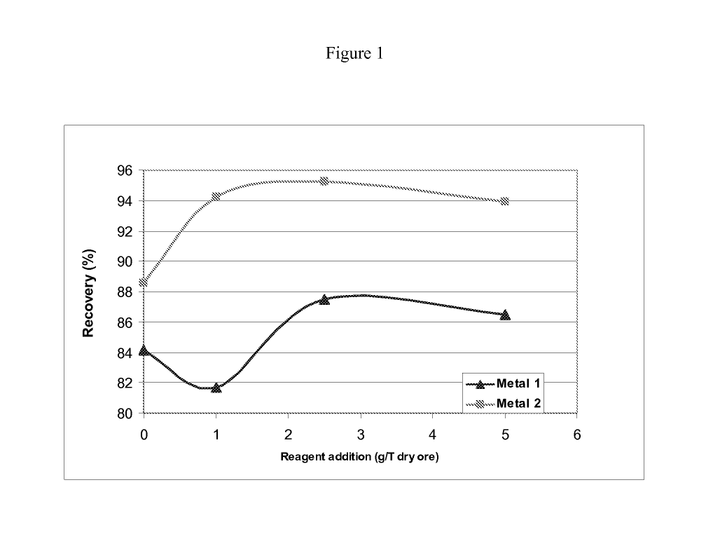

In one example, an average concentration of metal 1 in the ore was about 0.4 to 0.55 % and in concentrates was about 5.5 to 5.9%, and the recovery of metal 1 was varied from 83 to 85%. An average concentration of metal 2 in the ore was about 0.24 to 0.36 % and in concentrates was about 3.2 to 3.6%, and the recovery of metal 2 was varied from 86 to 89%. When the treatment reagent was added to a grinding mill at varied dosage levels, the recovery of valuable metals was significantly increased without any modification in the process. The recovery of Metal 1 was increased by 3.5% and the recovery of Metal 2 was increased by 6.7%. The content of gangues, including SiO₂, in the concentrate containing Metal 1 and Metal 2 was decreased. The results are summarized in Table 1 and demonstrated in graphic form in FIG. 1.

Table 1 shows the average metal recoveries at different reagent dosage levels.

TABLE 1

| Reagent addition | Metal 1 | Metal 2 |
|---|---|---|
| g/T dry ore | % Recovery | % Recovery |
| 0 | 84.18 | 88.57 |
| 1.0 | 81.68 | 94.24 |
| 2.5 | 87.49 | 95.24 |
| 5.0 | 86.46 | 93.90 |

The feed units are percent by dry weight and the reagent addition was added as grams of reagent per ton of dry ore. The reagent in this case was of the EO—PO-EO form.

While the present invention has been described with references to preferred embodiments, various changes or substitutions may be made on these embodiments by those ordinarily skilled in the art pertinent to the present invention with out departing from the technical scope of the present invention. Therefore, the technical scope of the present invention encompasses not only those embodiments described above, but also all that fall within the scope of the appended claims.

What is claimed is:

1. A method for separating mineral value from gangue in a polymetallic ore comprising
forming an aqueous mixture of mineral components and gangue,
adding to said mixture an effective amount of a treatment reagent comprised of a water soluble ethylene oxide/propylene oxide copolymer; and
subjecting said aqueous mixture to a separating process that selectively concentrates metal values in a froth or concentrate.

2. The method of claim 1 wherein the ethylene oxide/propylene oxide chosen from the forms comprising,
a) EO—PO-EO;
b) PO-EO—PO; 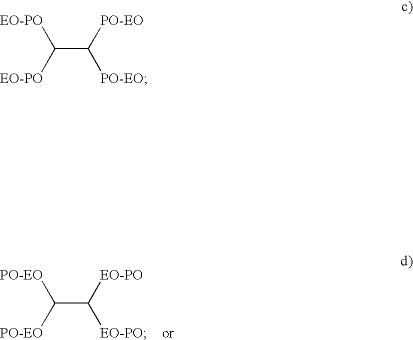
combinations thereof.

3. The method of claim 1 wherein the copolymer is the product of a controlled addition of propylene oxide to two hydroxyl groups of propylene glycol.

4. The method of claim 1 wherein the copolymer is the product of a sequential addition of propylene oxide and ethylene oxide to ethylene-diamine.

5. The method of claim 1 wherein the copolymer is present in the form of EO—PO-EO.

6. The method of claim 1 wherein the copolymer is a combination of ethyleneoxide-propylene oxide copolymers with different ethylene oxide concentrations by weight.

7. The method of claim 1 wherein the mineral ore comprises polymetallic ore.

8. The method of claim 1 wherein there is an increase in recovery values from the addition of the reagent from about 2.0% to about 10.0%.

9. The method of claim 1 wherein there is an increase in recovery values from the addition of the reagent from about 3.0% to about 8.0%.

10. The method of claim 1 wherein said polymetallic ore is a low grade ore and said froth or concentrate has a concentration of one or more metal values, each of which is increased from at least about five fold.

11. The method of claim 1 wherein said method increases recovery of metal values.

12. The method of claim 11 wherein said method reduces the level of metal values in tailings.
